(19) United States
(12) Patent Application Publication
(10) Pub. No.: US 2008/0020486 A1
(43) Pub. Date: Jan. 24, 2008

(54) Case For Sampling Water And Capturing Substances That Generate Orders And/Or Tastes Present In Water

(75) Inventors: Elise Corbi, Saint Germain en Laye (FR); David Benanou, Sartrouville (FR); John Cigana, Montreal (CA)

Correspondence Address: COATS & BENNETT, PLLC, 1400 Crescent Green, Suite 300, Cary, NC, 27518, US

(73) Assignee: VEOLIA EAU - COMPAGNIE GENERALE DES EAUX, Paris (FR)

(21) Appl. No.: 11/720,166

(22) PCT Filed: Nov. 24, 2005
(86) PCT No.: PCT/EP05/56208

§ 371 Date: Jul. 30, 2007

(30) Foreign Application Priority Data
Nov. 25, 2004 (FR) 04/12548

(51) Int. Cl. B01D 15/08; B01L 11/00; B01L 3/00; G01N 1/10

(52) U.S. Cl. 436/178; 422/102; 422/61; 422/69

(57) ABSTRACT

The invention relates to a case for sampling water and capturing substances that generate odors and/or tastes present in water, comprising: at least one sample vial serving to contain a water sample, and means for capturing said substances contained in this sample.

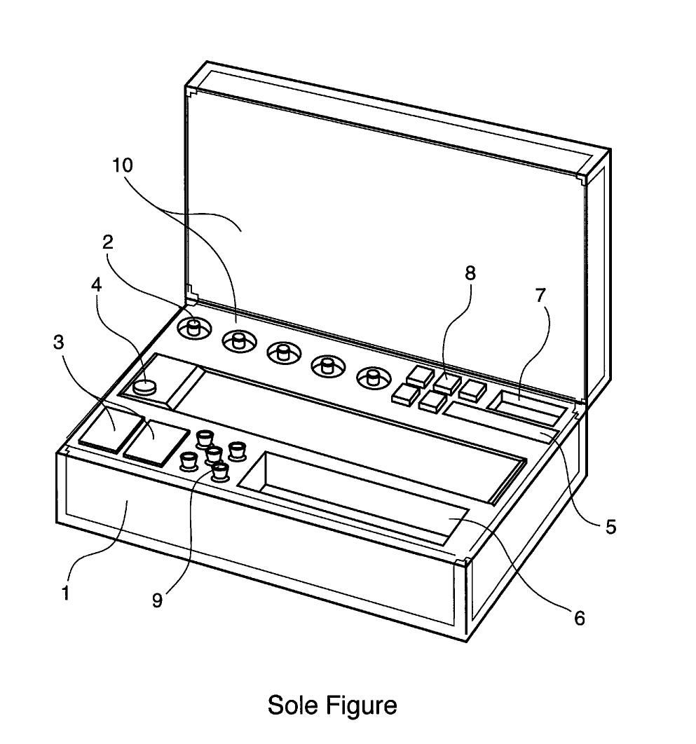

The field of the invention is that of the distribution of drinking water. More precisely, the invention relates to a method and a technique for sampling, analysing and detecting odoriferous compounds in water.

In the field of the invention, it is mandatory for the quality of drinking water distributed by a system to be monitored periodically or in response to requirements.

These controls can be initiated, in particular, when a particular taste and/or odour, characteristic or not, are detected by an individual or a user (of a distribution system).

At present, when a bad taste and/or a bad odour is detected in water, the procedure is as follows:

the “client” calls the complaint centre associated with the water distribution system;

a member of the water distribution system staff arrives at the location of the detection in order to collect a sample of water in a vial;

the sample is sent to a laboratory for analysis;

the substances generating the taste and/or odour are extracted;

the extracted substances are analysed.

The extraction times are generally around 2 hours and the analysis is carried out within the next 24 hours.

Such being the case, it is known that the appearance of taste and/or odour-generating substances in water is a fleeting phenomenon over time and that the odour (or taste) thresholds of the responsible compounds are extremely low with respect to the sensitivity of the detection materials currently used.

Consequently, the above-described procedure quickly reaches its limits in terms of efficiency.

In other words, this conventional procedure poses the problem of preserving the completeness of the “matrix” responsible for the taste or odour of water, between the time of sampling and that of the laboratory extraction procedure.

However, this procedure is the only one to date which makes it possible to characterise the origin of the odour (or taste) of some water.

Thus, the objective of the invention, in particular, is to mitigate this disadvantage of the prior art.

More precisely, the objective of the invention is to propose a technique for sampling water and for extracting the substances generating the taste and/or odour of the sampled water, which ensures a greater degree of efficiency than the procedure of the prior art.

In this sense, the objective of the invention is to provide such a technique making it possible to extract and analyse all of the taste and/or odour-generating substances of water.

The invention also has the objective of providing such a technique which is simple to implement, including by non-technical personnel.

The invention likewise has the objective of providing such a technique which is simple in design.

These objectives, as well as others which will become apparent below, are attained thanks to the invention, the object of which is a case for sampling water and capturing substances that generate odours and/or tastes present in water, including:

at least one sampling vial intended to contain a water sample;

means for capturing said substances contained in said sample.

Thus, owing to the invention, the extraction procedure can be carried out directly after sampling, directly at the location of the consumer having lodged a complaint, which makes it possible to preserve the “matrix” responsible for the taste or odour of the sampled water. This operation does not require any particular conditions for implementation and the consumer themselves can carry out said operation.

The invention thus makes it possible to significantly improve the performance of the analysis aiming to identify the sought-after substances and, as a result, to anticipate the actions aiming to improve the quality of the water in question.

Moreover, the sampling and extraction can be carried out on site by any person, which avoids the travel of a skilled person and the corresponding costs.

Thus, the advantages of the invention lie in:

the capability of extracting at the very location where the complaint was registered;

the simplicity but also the speed of implementation;

a considerable savings in time with regard to the laboratory analysis.

This capability of simultaneously improving productivity, simplicity, sensitivity and selectivity was laboratory tested and made it possible to respond to numerous unsolved cases of tastes and odours in water.

The technique itself was validated for the extraction and quantification of the most frequently encountered odoriferous compounds. In addition, an in-depth study was carried out on preserving the extraction means (i.e., trapping the compounds over time). This laboratory-conducted study demonstrated that, once trapped, even compounds having a low concentration are stable for at least for 7 days.

According to a preferred solution, said capturing means are of the type acting via sorption.

In this case, said capturing means preferably include at least one support covered with a thickness of polydimethylsiloxane.

Such capturing means turn out to be particularly simple to use and can therefore be implemented by a non-technical person.

According to one advantageous solution, the case also includes means for stirring said support in said vial.

In this way, it is possible to accelerate the extraction time and, as a result, facilitate the capture of the compounds.

In this case, said support or supports preferably each include a glass bar inside of which a magnetic stirring bar is encapsulated, the case also including a stirring table capable of acting via magnetic effect on said stirring bar so as to drive it in rotation.

In this way, a simple, efficient and particularly space-saving means is obtained, within the context of a portable piece of equipment intended for use by a non-technical person.

According to a preferred solution, the case includes means for storing said capturing means after their removal from said sampling vial or vials.

In this case, said storage means include at least one isothermal tube.

The sampled substances are thus protected from the effects of temperature during the time period between extraction and laboratory analysis.

Said sampling vial or vials are advantageously graduated.

The user thus knows unequivocally what quantity of water they must sample, without it being necessary for them to have particular skills for carrying out such a sampling.

The case preferably includes at least one predetermined dose of solvent.

The solvent makes it possible to considerably improve the capture of the substances on the stirring bar and prevents said substances from becoming attached first to the vial, to the detriment of them being captured by the capturing means.

The case advantageously includes means for handling said capturing means.

In this way, the capturing means are prevented from being polluted by the user themselves, which would obviously be likely to falsify the analyses.

In addition, the case advantageously includes at least one pair of gloves, which contributes to protecting the integrity of the extraction carried out.

Other characteristics and advantages of the invention will become more apparent upon reading the description of a preferred embodiment of the invention, given for non-limiting and illustrative purposes, with reference to the single FIGURE, which is a schematic view of a case according to the invention for sampling water and for extracting substances contained in the water.

As already mentioned previously, the principle of the invention lies in the fact of providing a piece of equipment ready for use on site for sampling water, including means for capturing substances contained in water.

With reference to the single FIGURE, according to this embodiment of the invention, a case 1 is provided to have:

five graduated sampling vials 2;

two boxes containing means for capturing 3 substances generating the taste and/or odour of the water (each capturing means itself being preserved in an initial mini-vial);

In addition, the case also contains:

a stir plate 4;

a space 5 for tongs with magnetic ends, which make it possible to handle the stirring bar without touching it;

a space 6 for a pair of cotton gloves 6

five severable ampoules containing 5 ml of solvent 8;

five isothermal protective vials 9 intended for receiving the capturing means after extraction;

a space 7 for stretch film making it possible to cover the protective vials, thereby preventing any outside pollution.

The various spaces of the case are defined by recesses made in a block of preformed foam 10, a block 10 such as this also being placed inside the lid of the case.

The capturing means are of the type sold under the name Twister (registered trademark) and are described in the patent document published under the number EP 1 039 288 A1. They are in the form of a glass bar in which a magnetic stirring bar is encapsulated, the 2-cm glass bar being coated with approximately 0.5 mm (corresponding to a volume of 47 μl) of polydimethylsiloxane, acting via sorption on the micropollutants contained in the water, in order to trap them.

The stir plate 4 is designed to act by magnetic effect on the stirring bar encapsulated in the glass bar, so as to cause the capturing means to rotate when they are placed inside a sampling vial and when the latter is positioned on the stir plate.

Using the case just described, a person who detects a bad taste or a bad odour in water can follow the following procedure:

five sampling vials 2 are filled with tap water up to a reference line on each vial;

the contents of one ampoule of solvent 8 is poured into each of the vials;

the vials are placed on the stir plate 4

the cotton gloves are slipped on by the user

the capturing means as described previously are withdrawn from their storage box and from their initial mini-vials in which they are preserved, then introduced into each of the vials containing the water sample;

the stir plate 4 is turned on in the position corresponding to optimal stirring (position 7) of the glass stirring bar;

the extraction process is carried out for at least two hours;

the capturing means are withdrawn from the vials and placed in the respective initial mini-vials, themselves placed in the isothermal protective vials 9, this being done by means of the tongs 5 with magnetic ends

the protective vials 9 are sealed by means of stretch film;

the protective vials 9 are sent to a laboratory for analysis.

Preferably, the case also includes a predetermined dose of ethanol containing an odoriferous reference substance marked with deuterium, enabling quantification of the odoriferous compounds trapped on said support.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A case for sampling water and capturing substances that generate odors and/or tastes present in water, including:
a. at least one sampling vial intended to contain a water sample; and
b. means for capturing said substances contained in said sample.

13. The case of claim 12 wherein said capturing means are of the type acting via sorption.

14. The case of claim 12 wherein said capturing means include one or more supports covered with a thickness of polydimethylsiloxane.

15. The case of claim 14 further including means for stirring said support in said vial.

16. The case of claim 14 wherein said one or more supports include a glass bar in which a magnetic stirring bar is encapsulated, the case including a stirring table capable of acting via magnetic effect on said stirring bar so as to drive it in rotation.

17. The case of claim 12 including means for storing said capturing means after removal from a sampling vial or vials.

18. The case of claim 17 wherein said storage means include at least one isothermal tube.

19. The case of claim 17 wherein said sampling vial or vials are graduated.

20. The case of claim 12 including at least one predetermined does of solvent.

21. The case of claim 12 including means for handling said capturing means.

22. The case of claim 12 including at least one pair of gloves.

23. A kit for extracting samples of odor-forming materials from water, the kit including:
a. a case for containing articles;
b. the articles including one or more of a substantial number of articles selected from the group including:
i. a water sampling vial;
ii. a solvent ampoule;
iii. a capturing or extracting and stabilizing device;
iv. a stir plate;
v. a pair of gloves;
vi. a set of tongs with magnetic ends; and
vii. a captured or extracted sample storage vial;
c. wherein the case includes compartments formed therein to receive each of the articles;
d. wherein the kit is adapted to enable extracting selected materials and stabilizing the extracted materials at a location where the water samples are collected; and
e. wherein the extracted sample storage vial is adapted for transport to a laboratory for analysis.

24. The kit of claim 23 including one or more of all of the articles of the group.

25. The kit of claim 23 including one or more of the following articles of the group: a water sampling vial; a solvent ampoule; and a capturing or extracting stabilizing device.

26. The kit of claim 25 further including one or more sampling storage vials.

27. A method of extracting samples of selected materials from water including:
a. procuring a sample of water in a water sampling vial at a sampling site;
b. adding a solvent to the water sampling vial at the sampling site;
c. inserting a capturing or extracting device into the water sampling vial at the sampling site;
d. capturing and stabilizing the selected materials onto the extracting device at the sampling site;
e. removing the extracting device from the water sampling vial and inserting the extracting device into an extracted sample storage vial at the sampling site; and
f. transporting the extracted storage vial from the sampling site to a laboratory for analysis.

28. The method of claim 27 including storing the extracted sample storage vial in the case at the sampling site.
